(19) United States
(12) Patent Application Publication
(10) Pub. No.: US 2009/0243506 A1
(43) Pub. Date: Oct. 1, 2009

(54) METHOD AND DEVICE FOR DRIVING A LAMP

(75) Inventors: Petrus Johannes Bremer, Eindhoven (NL); Alexander Christiaan De Rijck, Eindhoven (NL); Wilhelmus Ettes, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/295,658

(22) PCT Filed: Mar. 29, 2007
(86) PCT No.: PCT/IB2007/051106

§ 371 Date: Oct. 1, 2008

(30) Foreign Application Priority Data
Apr. 6, 2006 (EP) 06112315.4

(51) Int. Cl. H05B 41/36

(52) U.S. Cl. 315/287

(57) ABSTRACT

A method for driving a lamp with a variable duty cycle in a timing relationship with an input image signal (Si) comprises the steps of: receiving the image signal having a predetermined frame period (t3−t1); generating a high-frequency inverter signal (Sv); based on the received image signal, generating a dimming command signal (Sdcc) determining a target ON time (t1) for the lamp and determining a target OFF time (t2) for the lamp, such that the duty cycle (Δ=(t2−t1)/(t3−t1)) has a desired value; on the basis of the target ON time, determining an adapted ON time (ti 1) coinciding with a first predetermined phase of the high-frequency inverter signal; on the basis of the target OFF time, determining an adapted OFF time (t12) coinciding with a second predetermined phase of the inverter signal; switching the lamp ON at the adapted ON time and switching the lamp OFF at the adapted OFF time.

### FIELD OF THE INVENTION

The present invention relates in general to a device for driving a lamp, especially a device for driving a fluorescent gas discharge lamp.

### BACKGROUND OF THE INVENTION

Lamps in general have a nominal rating, i.e. nominal operational voltage and current providing a nominal light output. In general, there is a need for being able to operate a lamp in a dimmed mode, such that the actual light output is less than nominal. Dimming can be achieved by reducing the lamp current, but in the case of gas discharge lamps it is also known to drive the lamps in a switched mode (alternating ON/OFF) with variable duty cycle. During the ON periods, the lamp receives nominal power; during the OFF periods, the lamp receives no power. If the ON/OFF switching frequency is high enough (at least above 20 Hz), the resulting light output is the timeaverage of the light output during the ON periods and the light output during the OFF periods. This average depends on the duty cycle Δ, defined as Δ=t_{ON}/(t_{ON}+t_{OFF}).

As an example of an application, the backlighting of an LCD panel is mentioned. For backlighting of an LCD panel, for use in an LCD TV or an LCD monitor, it is known to arrange an array of horizontal fluorescent lamps behind the LCD. An LCD driver receives image signals, and controls the LCD cells to be transparent, partly transparent, or not transparent, i.e. to pass the lamp light or not. The LCD cells thus define image pixels. In a bright portion of the image, the LCD cells are transparent so that the lamp light passes and the corresponding image pixels are bright. In a dark portion of the image, the LCD cells are opaque so that the lamp light is blocked and the corresponding image pixels are dark. In this way, a contrast ratio of approximately 1:200 to 1:500 can be achieved. For good picture quality, however, a contrast ratio of at least 1:1200 or preferably even 1:1800 is desirable. This further increase in the contrast ratio can be provided by dimming the lamps. A lamp dimming controller switches the lamps ON and OFF on the basis of the image signals. Thus, in a backlight system for LCD TV or LCD monitors, the lamps are typically operated with a switching frequency equal to the frame frequency (typically between 50 Hz and 125 Hz, depending on the setting of the apparatus concerned), and a duty cycle varies in a typical range from 2% to 20%, although the duty cycle may even be set as high as 40%. In such situation, the ON time can vary from 0.16 ms (2% duty cycle at 125 Hz) to 4 ms (20% duty cycle at 50 Hz) or more.

During the ON periods, the current in the fluorescent lamps is not a DC current but the current has a high-frequency current component from an inverter, the frequency being typically in the order of 20-200 kHz, more typically in the order of about 50 kHz. This frequency shall be indicated as HF current frequency, in contrast to the LF lamp frequency=frame frequency. Thus, during an ON period, the lamp receives a limited number of HF current cycles. In a situation of 2% duty cycle, this number of HF current cycles would be 20 for a lamp frequency of 50 Hz and a HF current frequency of 50 kHz; for higher lamp frequencies, this number would be even lower.

With such limited number of HF current cycles, the lamp condition at the moment of switching the lamp ON or OFF becomes important. If the lamp condition varies from one lamp cycle to the next, noticeable lamp flicker may occur, which is annoying to the user. The lower the duty cycle, the more noticeable such flicker effect will be.

One possible way of trying to avoid the above-mentioned problems is to provide synchronization between the inverter output frequency and the lamp switching frequency, using a PLL. However, this would mean that the HF inverter output frequency would necessarily be a multiple of the frame frequency, and would as such be fixed by the PLL. However, in most cases, the HF inverter output frequency is a control parameter of the inverter device itself, and the inverter should be able to change its output frequency without being restricted by other system components.

In general, the present invention aims to provide a solution to the above problems.

### SUMMARY OF THE INVENTION

According to an important aspect of the present invention, a lamp driver comprises a lamp dimming controller determining duty cycle timing for the lamp, possibly on the basis of image signals it receives. Such lamp dimming controller may be a conventional controller, outputting a dimming control signal that can have two levels, a first level (for instance HIGH) defining LAMP ON and a second level (for instance LOW) defining LAMP OFF. Alternatively, it is also possible that the dimming control signal is a pulsed signal, containing the timing information in the form of timing pulses. In any case, the dimming control signal is possibly generated on the basis of the image signals, and contains timing information (transition from LOW to HIGH or vice versa) determining when a specific lamp (or array of lamps) should be switched ON or OFF. In prior art lamp drivers, the lamp would be switched directly on the times determined by these timing informations. According to a further important aspect of the present invention, a lamp driver comprises a lamp switching controller which receives the timing information of the dimming control signal as input, and which also receives the HF inverter output signal as an input signal. The lamp switching controller generates a lamp switching command output signal for actually switching the lamp. For instance, the lamp switching output signal may be a two-level signal, the transition from one level to the second level (for instance the transition from LOW to HIGH) actually switching the lamp ON and the opposite transition actually switching the lamp OFF. Alternatively, the lamp switching output signal may be a pulsed signal. The lamp switching controller is designed to generate its switch ON command at a predetermined first phase of the HF inverter output signal, and is designed to generate its switch OFF command at a predetermined second phase of the HF inverter output signal. Preferably, the predetermined first phase is equal to the predetermined second phase, so that the number of lamp current cycles is always an integer.

More particularly, the lamp switching controller awaits the LAMP ON timing signal from the lamp dimming controller; after having received this LAMP ON timing signal, the lamp switching controller waits until the HF inverter output signal has the said predetermined first phase, and only then outputs the switch ON command. Similarly, the lamp switching controller awaits the LAMP OFF timing signal from the lamp dimming controller; after having received this LAMP OFF timing signal, the lamp switching controller waits until the HF inverter output signal has the said predetermined second phase, and only then outputs the switch OFF command.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 schematically shows a block diagram of an exemplary embodiment of a lamp driver according to the present invention;

FIG. 2 is a graph schematically illustrating the timing of various signals in the lamp driver according to FIG. 1;

FIG. 3 is a flow diagram schematically illustrating an example of the operation of the lamp driver;

FIG. 4 is a flow diagram schematically illustrating another example of the operation of the lamp driver.

### DETAILED DESCRIPTION OF THE INVENTION

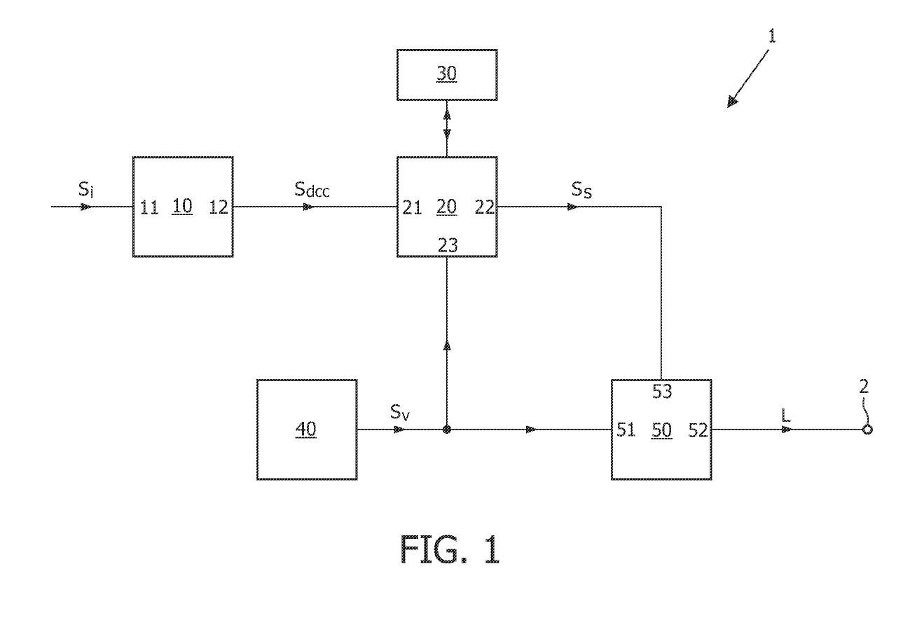

FIG. 1 schematically shows a block diagram of an exemplary lamp driver 1 according to the present invention, having an output 2 for connection to a lamp circuit (not shown). At its output 2, the lamp driver 1 outputs a lamp driving signal L. Depending on the lamp type, the lamp may be connected directly to the output 2, or the lamp should be incorporated in a lamp circuit comprising means for adapting the lamp driving signal, for instance comprising a transformer, as known per se.

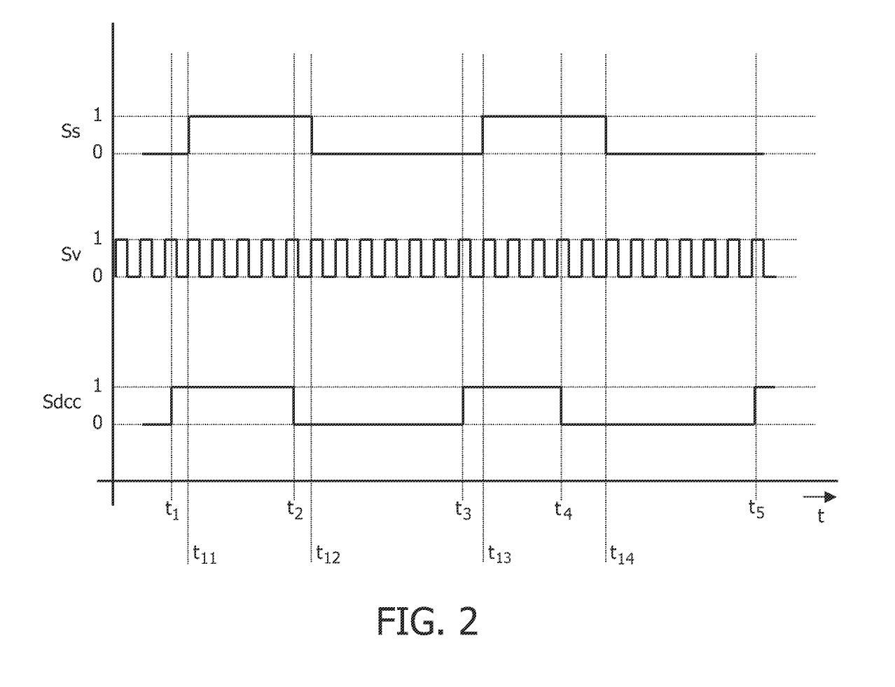

The lamp driver 1 comprises a lamp dimming controller 10, having an input 11 receiving image signals Si, and having an output 12 outputting a dimming control signal Sdcc. The image signal Si contains horizontal and vertical timing information for an image, and also contains pixel information. On the basis of this image signal Si, the lamp dimming controller 10 calculates a dim level for the driven lamp, and thus calculates a duty cycle for this lamp. Based on this duty cycle, the dimming control signal Sdcc contains timing information for switching the lamp ON and OFF in synchronization with the image signal Si. In this exemplary embodiment, the dimming control signal Sdcc is a two-level signal, wherein a HIGH level indicates LAMP ON and wherein a LOW level indicates LAMP OFF. FIG. 2 illustrates that the dimming control signal Sdcc contains timing information determining that a lamp controlled by the lamp driver 1 should be switched ON on time t1 and should be switched OFF on time t2, and should be switched ON again on time t3, to result in a duty cycle Δ=(t2−t1)/(t3−t1). It is noted that this is the timing intended by the lamp dimming controller 10, and the switch times t1 and t2 will therefore also be indicated as “target” times; as will be explained, the actual switching may occur at different times.

The lamp driver 1 further comprises an inverter 40 having an output 42 providing a high-frequency inverter signal Sv, also illustrated in FIG. 2. This output 42 is coupled to the driver output 2 through a controllable switch 50, which has two operative states. In a first operative state CLOSED, the switch 50 is conductive and passes signals received at its input 51 to its output 52; in this state, a driven lamp is ON. In a second operative state OPEN, the switch 50 is non-conductive and blocks all incoming signals received at its input 51; in this state, a driven lamp is OFF. Thus, switching the driven lamp ON and OFF is practiced by switching the controllable switch 50 to its CLOSED and OPEN states, respectively.

The lamp driver 1 further comprises a lamp switching controller 20, having an input 21 coupled to the output 12 of the lamp dimming controller 10 in order to receive the dimming control signal Sdcc, and having a control output 22 coupled to a control terminal 53 of the switch 50 is coupled to a control output 22 of a lamp switching controller 20. The lamp switching controller 20 is designed to generate at its control output 22 a switch control output signal Ss for determining the operative state of the controllable switch 50. For convenience sake, it will be assumed that the switch control output signal Ss is a two-level signal, wherein a HIGH value of the switch control output signal Ss determines the switch's CLOSED state and wherein a LOW value of the switch control output signal Ss determines the switch's OPEN state, respectively.

In a prior art device, the dimming command signal Sdcc would be coupled directly to the control terminal 53 of the switch 50. In such case, the driven lamp would be switched ON and OFF at the times t1 and t2, which have a random phase relation with the inverter output signal Sv, as shown in FIG. 2. In the present invention, the lamp switching controller 20 is arranged between the lamp dimming controller 10 and the controllable switch 50. The lamp switching controller 20 is designed to generate its output control signal Ss on the basis of the dimming command signal Sdcc received at its first input and the inverter output signal Sv received at a second input 23. More particularly, after time t1 when the dimming command signal Sdcc makes a transition from LOW to HIGH, the lamp switching controller 20 waits until the inverter output signal Sv has a first predetermined phase on t11, and only then makes its output control signal Ss HIGH, as illustrated in FIG. 2. Thus, the driven lamp L is always switched ON in a predetermined phase relationship with the inverter signal Sv, without a true synchronization between the lamp switching signal and the inverter signal being required. In the example shown in FIG. 2, the first predetermined phase of the inverter output signal Sv is the transition from LOW to HIGH.

In a similar manner, after time t2 when the dimming command signal Sdcc makes a transition from HIGH to LOW, the lamp switching controller 20 may wait until the inverter output signal Sv has a second predetermined phase on t12, and only then makes its output control signal Ss LOW. Thus, the driven lamp is always switched OFF in a predetermined phase relationship with the inverter signal Sv, without a true synchronization between the lamp switching signal and the inverter signal being required. In the example shown in FIG. 2, the second predetermined phase of the inverter output signal Sv is equal to the first predetermined phase (i.e. the transition from LOW to HIGH), so that the ON-time (t12−t11) of the output control signal Ss of the lamp switching controller 20 always is an integer multiple of the period of the inverter signal Sv. It is noted that this ON-time in general will not be equal to the ON-time (t2−t1) of the dimming command signal Sdcc.

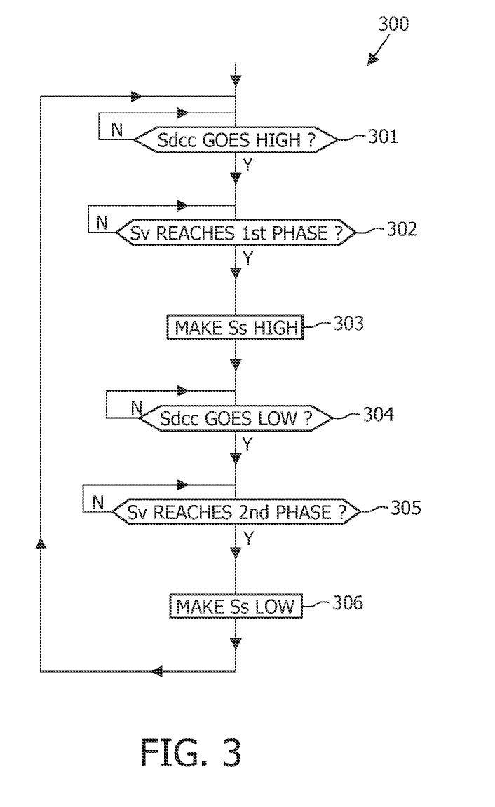

FIG. 3 is a flow diagram illustrating this operation 300 of the lamp driver 1. In a first step 301, the lamp switching controller 20 waits until the dimming command signal Sdcc goes HIGH. In a second step 302, after the dimming command signal Sdcc has gone HIGH, the lamp switching controller 20 waits until the inverter signal Sv reaches the first predetermined phase (i.e. goes HIGH). In a third step 303, at the moment when the inverter signal Sv reaches the first predetermined phase, the lamp switching controller 20 makes the switch control signal Ss HIGH in order to make the driven lamp go ON. In a fourth step 304, the lamp switching controller 20 waits until the dimming command signal Sdcc goes LOW. In a fifth step 305, after the duty cycle command signal Sdcc has gone LOW, the lamp switching controller 20 waits until the inverter signal Sv reaches the second predetermined phase (i.e. goes HIGH). In a sixth step 306, at the moment when the inverter signal Sv reaches the sixth predetermined phase, the lamp switching controller 20 makes the switch control signal Ss LOW in order to make the driven lamp go OFF.

Considered on a time scale longer than the image frame period (which corresponds to t3−t1), said integer multiple may vary in time. For instance, in one frame the lamp ON time (i.e. t12−t11) may correspond to 18 inverter cycles, while in the next frame the lamp ON time may correspond to 19 inverter cycles. This results in an undesirable flicker effect noticeable to the human eye. Especially in cases where the duty cycle Δ as determined by the lamp dimming controller 10 remains constant, the number of inverter cycles during the lamp ON times should remain constant. This is achieved by a further elaboration, also illustrated in FIGS. 1 and 2.

In this preferred embodiment, the lamp driver 1 further comprises a memory 30 associated with the lamp switching controller 20. In each lamp period, the duration of the ON-part of the dimming command signal Sdcc (i.e. t2−t1) is stored into the memory, and the duration of the ON-part of the output control signal Ss (i.e. t12−t11) is stored into the memory. Both durations may be expressed in time units, but it is more convenient to express these durations as number of inverter cycles, indicated as Ndcc and Ns, respectively. In the example of FIG. 2, Ndcc from t1 to t2 is equal to 5, and Ns from t11 to t12 is equal to 5.

In the next lamp period (i.e. from t3 to t5 in FIG. 2), it is shown that the duration of the ON-part of the dimming command signal Sdcc (i.e. from t3 to t4) is shorter, so that Ndcc is equal to 4, which is stored in the memory 30. For determining the duration of the ON-part of the output control signal Ss (i.e. t14−t13), the lamp switching controller 20 takes Ndcc and Ns from the previous lamp period by reading the memory 30, and calculates the difference D=|Ndcc−Ns|. If this difference D is smaller than a predetermined threshold Nt, the lamp switching controller 20 uses Ns from memory 30 as duration of the ON-part of the output control signal Ss (i.e. t14−t13). If, on the other hand, said difference D is larger than or equal to said predetermined threshold Nt, the lamp switching controller 20 uses Ndcc from memory 30 as duration of the ON-part of the output control signal Ss. In any case, the thus calculated duration is stored in the memory 30 as new value for Ns. In a suitable embodiment, said predetermined threshold Nt is equal to 2.

Thus, effectively, a change in the duty cycle as determined by the lamp dimming controller 10 is delayed by at least one lamp cycle, until the change is large enough to result in a change in the length of the ON-part of the lamp of at least two inverter cycles. It is noted that in the first lamp cycle, the memory 30 will be empty. For such case, the lamp switching controller 20 may just follow the duty cycle command signal Sdcc.

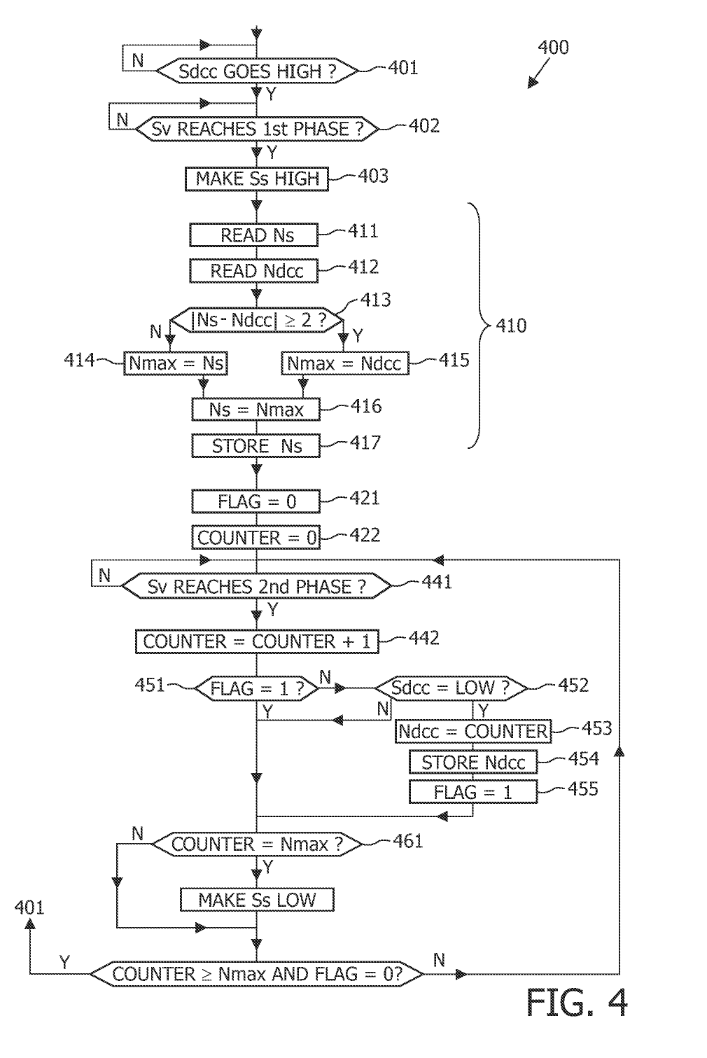

FIG. 4 is a flow diagram illustrating this operation 400 of the lamp driver 1. In a first step 401, the lamp switching controller 20 waits until the dimming command signal Sdcc goes HIGH. In a second step 402, after the dimming command signal Sdcc has gone HIGH, the lamp switching controller 20 waits until the inverter signal Sv reaches the first predetermined phase (i.e. goes HIGH). In a third step 403, at the moment when the inverter signal Sv reaches the first predetermined phase, the lamp switching controller 20 makes the switch control signal Ss HIGH in order to make the driven lamp go ON.

In a duration determination cycle 410, the lamp switching controller 20 determines the duration of the next ON-part of the switch control signal. The actual duration Ns of the previous cycle is read from memory 30 (step 411), and the target duration Ndcc as ordered by the lamp dimming controller 10 in the previous cycle is read from memory 30 (step 412). Ns is compared with Ndcc (step 413). If the difference is small, the duration Nmax of the next ON-part is determined to be equal to the actual duration Ns of the previous cycle (step 414); if, in contrast, the difference is large enough (at least equal to 2 in the example), the duration Nmax of the next ON-part is determined to be equal to the duration Ndcc as ordered by the lamp dimming controller 10 in the previous cycle (step 415). Subsequently, the value of Nmax is stored in the memory 30 as new value of Ns (steps 416-417).

In the embodiment of FIG. 4, the duration determination cycle 410 is performed after the third step 403; however, the duration determination cycle 410 may be performed earlier, for instance between the second step 402 and the third step 403, or between the first step 401 and the second step 402, or even before the first step.

In step 421, the lamp switching controller 20 resets a flag (of which the purpose will be explained later) to zero, and in step 421 the lamp switching controller 20 resets a counter to zero. Then, the lamp switching controller 20 waits until the inverter signal Sv reaches the second predetermined phase again (i.e. goes HIGH) (step 441). Whenever this happens, the lamp-ON duration is an exact integer multiple of the inverter period, and the counter value is increased by one (step 442); thus, the counter measures the lamp-ON duration.

In step 451, the value of the flag is checked; if the value of the flag is 1, the lamp switching controller 20 jumps to step 461. If the value of the flag is still zero, the lamp switching controller 20 checks the dimming command signal Sdcc (step 452); if this signal is still HIGH, the lamp switching controller 20 jumps to step 461. If it appears that the dimming command signal Sdcc has gone LOW during the last inverter cycle, the lamp switching controller 20 branches to step 453 to make Ndcc equal to the counter value, and this value is stored in the memory 30 (step 454). Then, the flag is set to value 1 (step 455), indicating that the new value for Ndcc has already been stored in the memory 30, and processing continues at step 261.

In step 462, the lamp switching controller 20 checks whether the counter value is equal to Nmax, indicating that the target lamp-ON duration has been reached. If so, the lamp switching controller 20 makes the switch control signal Ss LOW in order to make the driven lamp go OFF (step 462), otherwise this step is skipped.

In step 471, the lamp switching controller 20 checks whether the counter value is equal to or larger than Nmax, and whether the said flag is zero. If both these conditions are fulfilled, the lamp switching controller 20 jumps back to step 401 for a new lamp cycle, otherwise the lamp switching controller 20 jumps back to step 441 for the next inverter cycle.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for driving a lamp with a variable duty cycle, the method comprising the steps of:
providing a periodic signal that determines a lamp period (t3−t1) and a frame frequency;
generating a high-frequency inverter signal (Sv);
in a timing relationship with said periodic signal, generating a dimming command signal (Sdcc) determining a target ON time (t1) for the lamp and determining a target OFF time (t2) for the lamp, such that the duty cycle (Δ=(t2−t1)/(t3−t1)) has a desired value;
on the basis of the target ON time (t1), determining an adapted ON time (t11) coinciding with a first predetermined phase of the high-frequency inverter signal (Sv);
on the basis of the target OFF time (t2), determining an adapted OFF time (t12) coinciding with a second predetermined phase of the high-frequency inverter signal (Sv);
switching the lamp ON at the adapted ON time (t11) and switching the lamp OFF at the adapted OFF time (t12).

2. Method according to claim 1, wherein the frequency of the dimming command signal (Sdcc) is equal to the frame frequency of the said periodic signal.

3. Method according to claim 1, wherein the said first predetermined phase of the high-frequency inverter signal (Sv) is equal to the said second predetermined phase of the high-frequency inverter signal (Sv).

4. Method according to claim 1, wherein the dimming command signal (Sdcc) is a two-level signal, having a first level (HIGH) indicating “lamp ON” and having a second level (LOW) indicating “lamp OFF”, such that a transition from the first level (HIGH) to the second level (LOW) indicates the target ON time (t1) while a transition from the second level (LOW) to the first level (HIGH) indicates the target OFF time (t2).

5. Method according to claim 1, wherein the adapted ON time (t11) is determined by the steps of first waiting until the dimming command signal (Sdcc) indicates the target ON time (t1), and then detecting the first subsequent occurrence of the said first predetermined phase of the high-frequency inverter signal (Sv).

6. Method according to claim 1, wherein the adapted OFF time (t12) is determined by the steps of first waiting until the dimming command signal (Sdcc) indicates the target OFF time (t2), and then detecting the first subsequent occurrence of the said second predetermined phase of the high-frequency inverter signal (Sv).

7. Method according to claim 1, wherein the periodic signal is an input image signal (Si) having a predetermined frame period (t3−t1);
and wherein the dimming command signal (Sdcc) is generated on the basis of the received image signal (Si).

8. Method according to claim 1, wherein, during a first period of the periodic signal, the ON-duration of the dimming command signal Sdcc (i.e. t2−t1) is measured and the measured value (Ndcc) is stored into a memory (30), and the actual duration (Ns) between the actual time of lamp-ON switching (t11) and the actual time of lamp-OFF switching (t12) is stored into the memory (30); wherein the difference between said two measured values (D=|Ndcc−Ns|) is compared with a threshold value (Nt);
wherein, if said difference (D) is higher than or equal to said threshold value (Nt), the adapted OFF time (t12) of the subsequent period of the periodic signal is determined on the basis of said measured value (Ndcc) of the ON-duration of the dimming command signal, otherwise the adapted OFF time (t12) of the subsequent period of the periodic signal is determined on the basis of said actual lamp-ON duration (Ns).

9. Method according to claim 8, wherein the ON-duration of the dimming command signal Sdcc (i.e. t2−t1) is measured by counting the number of periods of the high-frequency inverter signal (Sv) between the target ON time (t1) and the target OFF time (t2).

10. Lamp driver (1) for driving a lamp, adapted for performing the method of claim 1.

11. Backlighting device for an LCD display device, comprising at least one backlighting lamp and at least one lamp driver (1) according to claim 10.
